(19) United States
(12) Patent Application Publication
(10) Pub. No.: US 2020/0269858 A1
(43) Pub. Date: Aug. 27, 2020

(54) ELECTRONIC FLANGING DEVICE, MONITORING DEVICE, AUTONOMOUS MOTOR VEHICLE, TRANSPORT SYSTEM, FLANGING METHOD AND COMPUTER PROGRAM PRODUCT THEREFOR

(71) Applicant: TRANSDEV GROUP, ISSY LES MOULINEAUX (FR)

(72) Inventor: Alexis BEAUVILLAIN, MASSY (FR)

(21) Appl. No.: 16/800,983

(22) Filed: Feb. 25, 2020

(30) Foreign Application Priority Data
Feb. 25, 2019 (FR) 19 01894

(51) Int. Cl. B60W 50/04; B60W 50/08; B60W 10/20; B60W 10/18; G07C 5/00; H04W 4/40; B60R 16/023; B60K 35/00; G05D 1/02

(52) U.S. Cl. CPC B60W 50/045; B60W 50/08; B60W 10/20; B60W 10/18; B60W 2050/008; H04W 4/40; B60R 16/0231; B60K 35/00; G05D 1/0291; G07C 5/008

(57) ABSTRACT

An electronic flanging device is for flanging the operation of a system. The system can be either a remote monitoring device for a fleet of autonomous motor vehicles for the remote piloting of the fleet by an operator or an autonomous vehicle belonging to a fleet of vehicles monitored by a remote monitoring device. The electronic flanging device includes a measuring module for measuring a lag in the communication between one of the autonomous vehicles and the monitoring device and a limiting module in order to limit the piloting of said autonomous vehicle by the operator as a function of the measured lag.

### CROSS-REFERENCE TO RELATED APPLICATIONS

This application is a U.S. non-provisional application claiming the benefit of French Application No. 19 01894, filed on Feb. 25, 2019, which is incorporated herein by reference in its entirety.

### FIELD OF THE INVENTION

The present invention relates to an electronic flanging device for flanging the operation of a system, the system being chosen from the group consisting of: a remote monitoring device for a fleet of autonomous motor vehicles for the remote piloting of the fleet by an operator and an autonomous vehicle belonging to a fleet of vehicles monitored by a remote monitoring device allowing the remote piloting of the fleet by an operator.

The invention relates to the field of autonomous motor vehicles, in particular autonomous motor vehicles having a level of automation greater than or equal to 3 on the scale of the Organisation Internationale des Constructeurs Automobiles [International Organization of Motor Vehicle Manufacturers] (OICA).

### BACKGROUND

In particular, the invention relates to the remote piloting of a vehicle by an operator. It is known, when an autonomous vehicle encounters a problematic situation, to allow a remote operator to take control of the vehicle in order to resolve this situation. For example, when a vehicle encounters an obstacle located on a path delimited by a sidewalk and a solid white line, the vehicle may potentially be unable to choose a strategy for bypassing the obstacle respecting the imposed safety setpoints. The operator taking control of the vehicle can then better take account of the situation and send a setpoint to the vehicle making it possible to resolve the problematic situation while ensuring the safety of the passengers of the vehicle.

However, the safety of the passengers of the vehicle during this remote piloting can be further improved, in particular in case of sent setpoint to bypass an obstacle or cross a white line by the vehicle.

### SUMMARY

One aim of the invention is thus to supply an electronic flanging device allowing improved safety for the passengers of the vehicle.

To that end, the invention relates to an electronic flanging device of the aforementioned type, wherein the monitoring device and the or each autonomous vehicle are able to communicate with one another, the electronic flanging device comprising: a module for measuring a lag in the communication between one of the autonomous vehicles and the monitoring device; and a limiting module in order to limit the piloting of said autonomous vehicle by the operator as a function of the measured lag.

According to one specific embodiment of the invention, the limiting module is configured to limit the piloting when the measured lag is above a predetermined safety threshold.

The invention also relates to a monitoring device comprising an electronic flanging device as defined hereinabove, the or each autonomous vehicle comprising at least one embedded sensor able to send at least one piece of information to the monitoring device, the monitoring device being able to receive at least one piece of information from at least one sensor formed by an embedded sensor on board one of the autonomous vehicles and comprising at least one display screen able to display the at least one piece of information, the measuring module being configured to measure the lag between the sending of the at least one piece of information by the first sensor and the display of the at least one piece of information on the display screen.

According to specific embodiments of the invention, the monitoring device also comprises one or more of the following features, considered alone or according to any technically possible combination(s):
the monitoring device comprises a control module able to send at least one movement command to the fleet, the limiting module being able to block the sending of any movement command to the autonomous vehicle;
the monitoring device is able to receive at least one piece of information from at least one second sensor, the second sensor being chosen from the group consisting of: a sensor embedded on board one of the autonomous vehicles and an infrastructure sensor positioned outside the autonomous vehicles, the limiting module being able to deactivate the communication between the monitoring device and the at least one second sensor;
the limiting module is able to deactivate the communication between the monitoring device and at least one of the vehicles of the fleet; and
the flanging device comprises an alert module able to emit an alert signal as a function of the calculated lag, the display screen being able to display the alert signal.

The invention also relates to an autonomous motor vehicle comprising an electronic flanging device as defined above, the monitoring device comprising a control module able to send at least one movement command to the fleet, the autonomous motor vehicle comprising at least one receiving module able to receive the at least one command, the measuring module being configured to measure the lag between the sending of the at least one command by the control module and the reception of the at least one command by the receiving module.

According to one specific embodiment of the invention, the autonomous vehicle comprises a transmission module able to transmit the at least one command to the rest of the vehicle, the limiting module being able to block the transmission of any movement command.

The invention also relates to a transport system comprising a monitoring device as defined above and a fleet of autonomous motor vehicles monitored remotely by the monitoring device, each autonomous motor vehicle being as defined above.

The invention also relates to a flanging device for the remote piloting of an autonomous motor vehicle belonging to a fleet of autonomous motor vehicles monitored using a remote monitoring device, the flanging method comprising the following steps:
computing a lag in the communication between one of the autonomous motor vehicles and the monitoring device; and
limiting the piloting of said autonomous motor vehicle by the operator as a function of the computed lag.

The invention also relates to a non-transitory computer-readable medium including a computer program including software instructions which, when executed by a computer, implement a flanging method as defined above.

### BRIEF DESCRIPTION OF THE DRAWINGS

The invention will be better understood using the following description, provided solely as an example and done in reference to the appended figures, in which:

FIG. 1 is a schematic view of a transport system according to the invention.

FIG. 2 is a block diagram illustrating a flanging method implemented by a flanging device embedded in a vehicle of the transport system of FIG. 1, and

FIG. 3 is a block diagram illustrating a flanging method implemented by a flanging device positioned in a monitoring building of the transport system of FIG. 1.

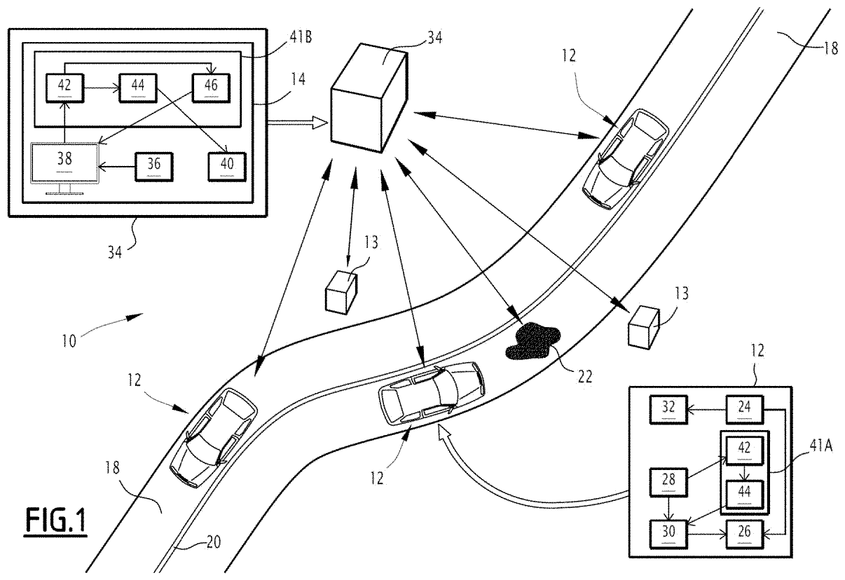

As shown in FIG. 1, a transport system 10 comprises a fleet of at least one vehicle 12, at least one sensor 13, also called infrastructure sensor, and a device 14 for remote monitoring of the fleet of vehicles 12 for the remote piloting of the fleet by an operator.

### DETAILED DESCRIPTION

Each motor vehicle 12 is able to circulate along circulation path(s) 18. Each circulation path 18 is part of a roadway allocated to vehicle traffic in a direction of travel. The roadway for example comprises a single traffic lane 18. In a variant, as shown in FIG. 1, the roadway comprises two traffic lanes 18 associated with opposite directions of travel and separated by a solid white line 20. In another variant, the roadway comprises two to four traffic lanes 18 in each direction of travel. Each traffic lane 18 is embodied by a marking on the ground, such as a white line, for example.

In the example illustrated in FIG. 1, an obstacle 22 is located in one of the traffic lanes 18. The obstacle 22 is able to hinder the travel of one of the vehicles 12 in the traffic lane 18. The obstacle 22 is for example a stone, dirt, part of a vehicle body, a plastic bag or a cavity in said traffic lane 18.

Hereinafter, a single vehicle 12 will be described. One skilled in the art will understand that the other vehicles 12 of the fleet are similar.

The vehicle 12 comprises, in a known manner, rear wheels, front wheels, a motor mechanically connected via a transmission chain to the rear and/or front wheels for the driving of said wheels in rotation around their axis, a steering system, suitable for acting on the front and/or rear wheels of the vehicle 12 so as to modify the orientation of its trajectory, and a braking system, suitable for exerting a braking force on the wheels of the vehicle 12.

The vehicle 12 is typically made up of a traction and/or electric propulsion vehicle. To that end, the motor is made up of an electric motor, and the vehicle 12 comprises an electric battery electrically connected to the motor to supply the motor with electricity.

The vehicle 12 is an autonomous motor vehicle. To that end, the vehicle comprises at least one sensor 24, also called embedded sensor, able to detect at least one piece of information relative to the vehicle 12 or the environment of the vehicle 12. In particular, the at least one sensor 24 is able to detect the obstacle 22 in the traffic lane 18. Each sensor 24 is for example a camera, an infrared sensor, a radar, a LIDAR, a temperature sensor, a pressure sensor and/or a humidity sensor.

The vehicle 12 further comprises an electronic autonomous driving device 26 suitable for piloting the vehicle 12 autonomously by receiving information on the environment of the vehicle 12 by means of sensors 24 and by acting on the motor, the steering system and the braking system, so as to modify the speed, the acceleration and the trajectory of the vehicle 12 in response to the received information.

The autonomous vehicle 12 preferably has a level of automation greater than or equal to 3 on the scale of the Organisation Internationale des Constructeurs Automobiles (OICA). The level of automation is then equal to 3, that is to say, a conditional automation, or equal to 4, that is to say, a high automation, or equal to 5, that is to say, a full automation.

According to the OICA scale, level 3 for conditional automation corresponds to a level for which the driver does not need to perform continuous monitoring of the driving environment, while still having to be able to take back control of the autonomous motor vehicle 12. According to this level 3, the electronic autonomous driving device 26, embedded on board the autonomous motor vehicle 12, then performs the longitudinal and lateral driving in a defined usage case and is capable of recognizing its performance limits to then ask the driver to take back dynamic driving with a sufficient time margin.

The high level of automation 4 then corresponds to a level for which the driver is not required in a defined usage case. According to this level 4, the electronic autonomous driving system 26, embedded on board the autonomous motor vehicle 12, then performs the dynamic longitudinal and lateral driving in all situations in this defined usage case.

The full automation level 5 lastly corresponds to a level for which the electronic autonomous driving system 26, embedded on board the autonomous motor vehicle 12, performs the dynamic lateral and longitudinal driving in all situations encountered by the autonomous motor vehicle 12, throughout its entire journey. No driver is then required.

Each vehicle 12 further comprises a command receiving module 28, a transmission module 30 and a sending module 32.

The command receiving module 28 is able to receive at least one movement command from the monitoring device 14.

A movement command is for example a command to modify the trajectory of the vehicle 12, a command to bypass the obstacle 22, a command to ignore the obstacle 22, a command to wait, a command to slow down or a command to stop the vehicle 12.

The command receiving module 28 is able to receive at least one movement command from the monitoring device 30.

The transmission module 30 is able to send at least one movement command to the rest of the vehicle 12.

In particular, the transmission module 30 is able to send the command to the electronic autonomous driving device 26 of the vehicle 12. The electronic autonomous driving device 26 is then configured to implement the command.

The sending module 32 is able to receive the at least one piece of information detected by the at least one embedded sensor 24 in one of the vehicles 12.

The sending module 32 is able to send the at least one piece of information to the monitoring device 14.

The electronic autonomous driving device 26, the command receiving module 28, the transmission module 30 and the sending module 32 are typically made in the form of software stored in a memory (not shown) and able to be executed by a processor (not shown) associated with said memory, the memory and the processor together forming an information processing unit included in the vehicle 12. In a variant, the electronic autonomous driving device 26, the command receiving module 28, the transmission module 30 and the sending module 32 are made in the form of a programmable logic component or in the form of a dedicated integrated circuit included in the car 12.

Each infrastructure sensor 13 is positioned along the traffic lanes 18. In particular, each infrastructure sensor 13 is located at a distance of less than 500 m from the traffic lanes 18. Each infrastructure sensor 13 is for example stationary, in the sense that its geographical position does not vary over time, while allowing a rotation of the infrastructure sensor 13 around at least one axis.

Each infrastructure sensor 13 is able to detect at least one piece of information on the environment of the infrastructure sensor 13. In particular, each infrastructure sensor 13 is for example a camera, a temperature sensor, a pressure sensor, a humidity sensor or a lidar.

Each infrastructure sensor 13 is able to send the at least one piece of information to the monitoring device 14.

The monitoring device 14 is positioned in a remote control station 34. The control station 34 is located at a distance from the vehicles 12 and ensures the control of the vehicle 12 by an operator.

The monitoring device 14 and the vehicles 12 are able to communicate with one another.

The monitoring device 14 comprises an information receiving module 36, at least one display screen 38 and a control module 40.

The information receiving module 36 is configured to receive the at least one piece of information sent by the at least one embedded sensor 24 of the at least one car 12.

In one advantageous embodiment, the monitoring device 14 is further able to receive information from at least one second sensor. The second sensor is chosen from among the group consisting of: an embedded sensor 24 in one of the autonomous vehicles 12 and one of the infrastructure sensors 13 positioned outside the autonomous vehicles 12.

Thus, the information receiving module 36 is able to receive information from at least two embedded sensors 24 on board autonomous vehicles 12 or able to receive information from at least one embedded sensor 24 and at least one of the infrastructure sensors 13 positioned outside the vehicles 12.

Each display screen 38 is able to display the at least one piece of information received by the monitoring device 14.

The control module 40 is able to send at least one movement command to the fleet of vehicles 12.

The movement command is advantageously determined by the operator as a function of the at least one piece of information displayed on the display screen 38.

The information receiving module 36 and the control module 40 are typically made in the form of software stored in a memory (not shown) and able to be executed by a processor (not shown) associated with said memory, the memory and the processor together forming an information processing unit included in the monitoring device 14. In a variant, the information receiving module 36 and the control module 40 are made in the form of a programmable logic component or in the form of a dedicated integrated circuit included in the monitoring device 14.

Each vehicle 12 also comprises an electronic flanging device 41A embedded on board the vehicle 12, able to flange the operation of said vehicle 12, and the monitoring device 14 comprises an electronic flanging device 41 B able to flange the operation of said monitoring device 14.

Each electronic flanging device 41A, 41 B comprises a measuring module 42 and a limiting module 44.

The measuring module 42 is able to measure a lag in the communication between one of the autonomous vehicles 12, called vehicle of interest, and the monitoring device 14.

The limiting module 44 is able to limit the piloting of the vehicle 12 of interest by the operator as a function of the measured lag. In particular, the limiting module 44 is configured to limit the piloting when the measured lag is above a predetermined safety threshold.

In the case electronic flanging device 41A, the vehicle of interest is constituted by the vehicle 12 on board of which the electronic flanging device 41A is embedded.

Regarding the electronic flanging device 41A, the measuring module 42 is in particular configured to measure the lag between the sending of the at least one command by the control module 40 and the reception of the at least one command by the command receiving module 28.

The lag is typically measured by difference between the sending time of the at least one command by the control module 40 and the reception time of the at least one command by the information receiving module 36. The sending module 32 is for example able to timestamp the information at the time of its sending and the information receiving module 36 is able to timestamp the information at the time of its reception. The measuring module 42 is then able to read the two timestamps and obtain the difference between them in order to determine the lag.

The limiting module 44 is then able to block the transmission of any movement command as a function of the measured lag.

In particular, the limiting module 44 is able to inhibit the transmission module 30 so as to prevent the transmission of the command to the electronic autonomous driving device 26 of the vehicle 12 of interest.

In particular, the limiting module 44 is able to block the transmission of any movement command when the measured lag is above a first predetermined threshold value. The first threshold value is for example greater than 100 ms.

The inhibition of the transmission module 30 by the flanging device 41A makes it possible to prevent the reception of commands by the electronic autonomous driving device 26 of the vehicle 12 of interest with too great a delay relative to their determination by the monitoring device 14. Indeed, such a delay can cause a movement of the vehicle 12 of interest that would no longer be relevant in light of the current reality of the environment of the vehicle 12 of interest. For example, the reception of a bypass setpoint of the obstacle 22 by the vehicle 12 by crossing the solid line 20 is potentially dangerous in case of presence of another vehicle 12 in the adjacent traffic lane 18 and for which the information relative to this presence has not yet been sent to the monitoring device 14. The inhibition of the transmission module 30 then makes it possible to guarantee the safety of the passengers of the vehicle 12 of interest.

Regarding the electronic flanging device 41 B, the measuring module 42 is in particular configured to measure the lag between the sending of the at least one piece of information by the sensor 24 embedded in the vehicle 12 of interest and the display of the at least one piece of information on the display screen 38.

The lag is typically measured by difference between the sending time of the at least one piece of information by the embedded sensor 24 and the display time of the at least one piece of information on the display screen 38. The control module 40 is for example able to timestamp the command at the time of its sending and the command receiving module 28 is able to timestamp the command at the time of its reception. The measuring module 42 is then able to read the two timestamps and obtain the difference between them in order to determine the lag.

The limiting module 44 is then able to block the sending by the control module 40 of any movement command to the vehicle 12 of interest as a function of the measured lag.

In particular, the limiting module 44 is able to block the sending of any movement command to the vehicle 12 of interest when the measured lag is above a second predetermined threshold value. The second threshold value is for example greater than 200 ms.

The blocking of the command sending makes it possible to avoid a dangerous movement of the vehicle of interest 12 when the reception of information by the monitoring device 14 is done with too great a delay relative to the sending thereof by the at least one embedded sensor 24 of the vehicle 12 of interest. Indeed, such a delay can cause the determination of a movement setpoint that would no longer be relevant in light of the current reality of the environment of the vehicle 12 of interest. The blocking of the command sending then makes it possible to guarantee the safety of the passengers of the vehicle 12 of interest.

Advantageously, the limiting module 44 is also able to deactivate the communication between the monitoring device 14 and at least one of the vehicles 12 of the fleet, in particular a vehicle 12 different from the vehicle 12 of interest.

In particular, the limiting module 44 is able to deactivate the communication between the monitoring device 14 and a vehicle 12 presenting a safety risk for the passengers that is less serious than for the vehicle 12 of interest.

Deactivating the communication with at least one of the vehicles 12 makes it possible to decrease the stream of information escalated by the cars 12 to the monitoring device 14 and thus to decrease the lag in the communication between the monitoring device 14 and the vehicle 12 of interest.

In one advantageous embodiment, when the monitoring device 14 is able to receive information from at least two embedded sensors 24 of the vehicle 12 of interest and/or an infrastructure sensor 13, the limiting module 44 is able to deactivate the communication between the monitoring device 14 and at least one of the sensors 24, 13.

In particular, the limiting module 44 is able to determine a criticality level associated with each sensor 24, 13. The criticality level reflects the potential impact of the information escalated by the sensor 24, 13 on the driving of the vehicle 12 of interest by the operator. The criticality level of a sensor is higher when the at least one escalated piece of information will have a strong impact on the setpoints sent by the operator. Thus, as an example, the criticality level associated with a camera is higher than that associated with a temperature sensor.

The limiting module 44 is able to deactivate the communication between the monitoring device 14 and the sensor(s) 24, 13 having the lowest criticality level.

Deactivating the communication with at least one sensor 24, 13 makes it possible to decrease the stream of information escalated by the sensor(s) 24, 13 to the monitoring device 14 and thus to decrease the lag in the communication.

The electronic flanging device 41 B also comprises an alert module 46.

The alert module 46 is able to emit an alert signal as a function of the calculated lag. In particular, the alert module 46 is able to send the alert signal to the at least one display screen 38, the display screen 38 being able to display the alert signal.

The alert module 46 is advantageously able to emit an alert signal when the measured lag is above a predetermined alert threshold. The alert threshold is in particular below the safety threshold. For example, the alert threshold is equal to 75 ms.

Thus, the display of an alert message allows the operator to anticipate a potential flanging due to an excessively high lag and to perform operations making it possible to reduce the lag, for example to cut the communication with one of the vehicles 12 of the fleet or to deactivate the communication with at least one sensor 24, 13.

The measuring module 42, the limiting module 44 and the alert module 46 are typically made in the form of software stored in a memory (not shown) and able to be executed by a processor (not shown) associated with said memory, the memory and the processor together forming an information processing unit included in the flanging device 41A, 41B. In a variant, the measuring module 42, the limiting module 44 and the alert module 46 are made in the form of a programmable logic component or in the form of a dedicated integrated circuit included in the flanging device 41A, 41B.

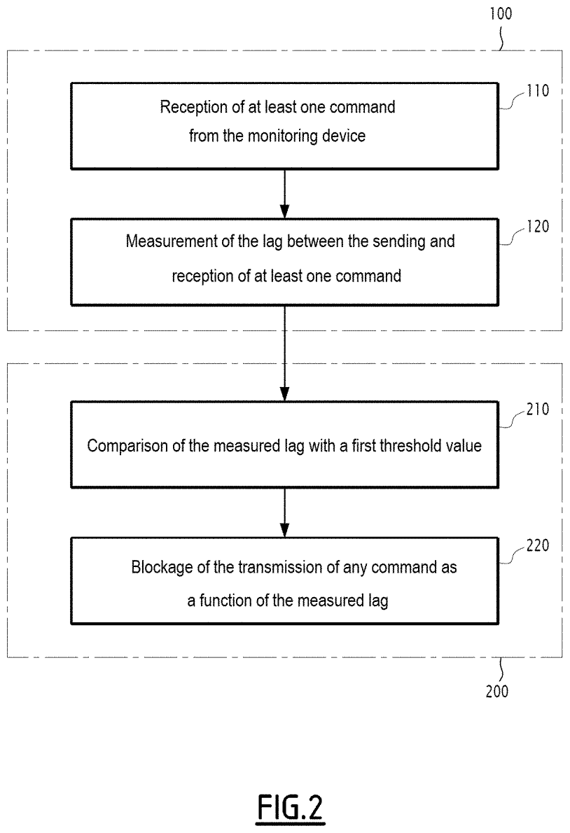

A flanging method of the remote piloting of an autonomous motor vehicle 12, implemented by the electronic flanging device 41A, will now be described, in reference to FIG. 2.

The flanging method comprises a first step 100 for calculating a lag in the communication between the monitoring device 14 and the vehicle 12, called vehicle of interest, on board of which the electronic flanging device 41A is embedded.

Step 100 is followed by a step 200 for limiting the piloting of the vehicle 12 of interest by the operator as a function of the calculated lag.

Advantageously, the limiting of the piloting is done when the measured lag is above a predetermined safety threshold.

Here, step 100 comprises a first sub-step 110 for reception by the command receiving module 28 of at least one command sent by the monitoring device 14.

Sub-step 110 is followed by a sub-step 120 for measuring of the lag between the sending of the at least one command by the control module 40 and the reception of the at least one command by the command receiving module 28.

Then, step 200 comprises at least a first sub-step 210 for comparison of the measured lag with the first threshold value.

Then, step 200 comprises a sub-step 220 for blocking the transmission of any movement command as a function of the calculated lag.

In particular, the limiting module 44 inhibits the transmission module 30 during this step 220 so as to prevent the transmission of the command to the electronic autonomous driving device 26 of the vehicle 12 of interest.

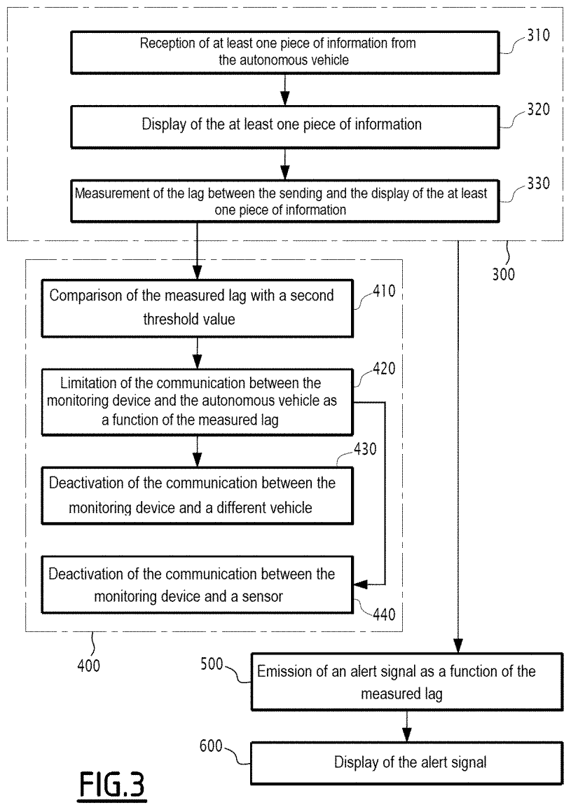

A flanging method of the remote piloting of an autonomous motor vehicle 12, implemented by the electronic flanging device 41 B, will now be described, in reference to FIG. 3.

The flanging method comprises a first step 300 for calculating a lag in the communication between the monitoring device 14 and a vehicle 12, called vehicle of interest.

Step 300 is followed by a step 400 for limiting the piloting of the vehicle 12 of interest by the operator as a function of the calculated lag.

Advantageously, the limiting of the piloting is done when the measured lag is above a predetermined safety threshold.

Here, step 300 comprises a first sub-step 310 for reception by the information receiving module 36 of the at least one first piece of information sent by at least one of the embedded sensors 24 of the vehicle 12 of interest, and advantageously by one of the infrastructure sensors 13.

Then, during sub-step 320, the at least one piece of information is displayed on the display screen 38.

Sub-step 320 is followed by a sub-step 330 for measuring the lag between the sending of the at least one piece of information by the embedded sensor 24 and the display of the at least one piece of information on the display screen 38.

Step 400 comprises a first sub-step 410 for comparison of the measured lag with the second threshold value.

Then, step 400 comprises a sub-step 420 for limiting the communication between the monitoring device 14 and the vehicle 12 of interest as a function of the computed lag.

In particular, the limiting module 44 flanges the control module 40 in order to prevent the sending of commands to the vehicle 12 of interest.

Then, during an optional sub-step 430, the limiting module 44 deactivates the communication between the monitoring device 14 and at least one of the vehicles 12 of the fleet, in particular different from the vehicle 12 of interest and having a lower safety risk than the vehicle 12 of interest.

In one advantageous embodiment, when the monitoring device 14 receives information from at least two embedded sensors 24 of the vehicle 12 of interest and/or an infrastructure sensor 13, step 400 also comprises a sub-step 440 for the deactivation of the communication between the monitoring device 14 and at least one of the sensors 24, 13.

In particular, the limiting module 44 deactivates the communication between the monitoring device 14 and the sensor(s) 24, 13 having the lowest criticality level.

The flanging method optionally comprises a step 500 following step 300. This step 500 is a step for emitting an alert signal as a function of the calculated lag.

In particular, during this step 500, the alert module 46 sends the alert signal to the at least one display screen 38.

Then, during a step 600, the display screen 38 displays the alert signal.

The alert module 46 advantageously emits an alert signal when the measured lag is above a predetermined alert threshold below the safety threshold.

Owing to the invention described above, the safety of the passengers of the vehicle is significantly improved. Indeed, inhibiting the transmission module 30 and/or blocking command sending in case of excessive measured lag makes it possible to avoid a movement of the vehicle 12 that would no longer be relevant in light of the current reality of the environment of the vehicle 12.

Furthermore, deactivating the communication with another vehicle 12 of the fleet and/or with at least one sensor 24, 13 makes it possible to decrease the stream of information exchanged with the monitoring device 14 and thus to decrease the lag of the communication between the monitoring device 14 and the vehicle 12 of interest in order to allow a piloting of the vehicle 12 of interest by the operator that is better suited to the reality.

Lastly, the display of an alert message allows the operator to anticipate a potential flanging due to an excessively high lag and to perform operations making it possible to reduce the lag in communication.

What is claimed is:

1. An electronic flanging device for flanging the operation of a system, the system being selected from the group consisting of:
a remote monitoring device for a fleet of autonomous motor vehicles for the remote piloting of the fleet by an operator; and
an autonomous motor vehicle belonging to a fleet of vehicles monitored by a remote monitoring device allowing the remote piloting of the fleet by an operator;
the monitoring device and the or each autonomous motor vehicle being able to communicate with one another,
the electronic flanging device comprising:
a measuring module for measuring a lag in the communication between one of the autonomous motor vehicles and the monitoring device; and
a limiting module in order to limit the piloting of said autonomous motor vehicle by the operator as a function of the measured lag.

2. The electronic flanging device according to claim 1, wherein the limiting module is configured to limit the piloting when the measured lag is above a predetermined safety threshold.

3. A monitoring device comprising an electronic flanging device according to claim 1, the or each autonomous motor vehicle comprising at least one embedded sensor able to send at least one piece of information to the monitoring device, the monitoring device being able to receive at least one piece of information from at least one sensor formed by an embedded sensor on board one of the autonomous motor vehicles and comprising at least one display screen able to display the at least one piece of information, the measuring module being configured to measure the lag between the sending of the at least one piece of information by the first sensor and the display of the at least one piece of information on the display screen.

4. The monitoring device according to claim 3, wherein the monitoring device comprises a control module able to send at least one movement command to the fleet, the limiting module being able to block the sending of any movement command to the autonomous motor vehicle.

5. The monitoring device according to claim 3, wherein the monitoring device is able to receive at least one piece of information from at least one second sensor, the second sensor being selected from the group consisting of: a sensor embedded on board one of the autonomous motor vehicles and an infrastructure sensor positioned outside the autonomous motor vehicles, the limiting module being able to deactivate the communication between the monitoring device and the at least one second sensor.

6. The monitoring device according to claim 3, wherein the limiting module is able to deactivate the communication between the monitoring device and at least one of the vehicles of the fleet.

7. The monitoring device according to claim 3, wherein the flanging device comprises an alert module able to emit an alert signal as a function of the calculated lag, the display screen being able to display the alert signal.

8. An autonomous motor vehicle comprising an electronic flanging device according to claim 1, the monitoring device comprising a control module able to send at least one movement command to the fleet, the autonomous motor vehicle comprising at least one receiving module able to receive the at least one command, the measuring module being configured to measure the lag between the sending of the at least one command by the control module and the reception of the at least one command by the receiving module.

9. The autonomous motor vehicle according to claim 8, wherein the autonomous vehicle comprises a transmission module able to transmit the at least one command to the rest of the vehicle, the limiting module being able to block the transmission of any movement command.

10. A transport system comprising:
a monitoring device according to claim 3; and
a fleet of autonomous motor vehicles monitored remotely by the monitoring device.

11. A transport system comprising:
a monitoring device; and
a fleet of autonomous motor vehicles monitored remotely by the monitoring device, at least one of the autonomous motor vehicles being according to claim 8.

12. A flanging method for the remote piloting of an autonomous motor vehicle belonging to a fleet of autonomous motor vehicles monitored using a remote monitoring device allowing the remote piloting of the fleet by an operator, the flanging method comprising the following steps:
computing a lag in the communication between one of the autonomous motor vehicles and the monitoring device; and
limiting the piloting of said autonomous motor vehicle by the operator as a function of the computed lag.

13. A non-transitory computer-readable medium including a computer program product including the software instructions which, when implemented by a piece of computer equipment, carry out the flanging method according to claim 12.
